(19) United States
(12) Patent Application Publication
(10) Pub. No.: US 2013/0173388 A1
(43) Pub. Date: Jul. 4, 2013

(54) METHODS AND SYSTEMS FOR SERVICE DISCOVERY AND SELECTION

(71) Applicants: Duy Ngan LE, Singapore (SG); Rajaraman Kanagasabai, Singapore (SG)

(72) Inventors: Duy Ngan LE, Singapore (SG); Rajaraman Kanagasabai, Singapore (SG)

(21) Appl. No.: 13/730,114

(22) Filed: Dec. 28, 2012

(30) Foreign Application Priority Data
Dec. 28, 2011 (SG) 201109695-5

(51) Int. Cl. G06Q 30/02

(52) U.S. Cl. CPC G06Q 30/0256
USPC 705/14.54

(57) ABSTRACT

A systems and method are proposed that address the task of locating advertised services satisfying specific requirements described by a service request, and ranking discovered services so as to enable selection of best services among them. Real life scenarios often involve services described with complex pre- and post-conditions, and have Quality of Service (QoS) associated with them. The proposed method and apparatus support a unified matching of functional as well as non-functional service properties: input-output, complex constraints, and QoS. A novel service discovery and selection algorithm can adaptively locate advertised services by performing a flexible matching of the three service properties. The algorithm is capable of returning partially matched services should there be no exact match.

### FIELD OF THE INVENTION

The present invention aims to provide methods and systems for permitting a user who wishes to obtain a service (a “service requester”), to obtain information relating to services (“advertised services”) provided by service providers, to enable a choice to be made from among the services offered by the service providers.

### BACKGROUND OF THE INVENTION

The field of Services Computing (SC) aims to utilize services as the basic building blocks for the development of distributed applications in heterogeneous environments. SC envisions a world of cooperating services where application components are assembled with little effort into a network of services that can be loosely coupled to create flexible, dynamic business processes and agile applications that may span organizations and computing platforms. Services computing enables efficient re-use of existing applications, and agile design, development and customization of software and applications based on changing customer requirements.

A standard service-oriented ecosystem comprises service providers advertising services, and service requesters describing requirements in order to locate the advertised services. The service which is advertised by providers is called an “advertised service” and the service which is described by requester is called a “requested service”. This is a generic formulation of service discovery encountered in several computing paradigms. For example,
Internet Protocol Television (IPTV), which deals with multimedia services delivered over IP based networks managed to provide the required level of quality of service and experience, security, interactivity and reliability, involves IPTV services (such as linear TV, Video on Demand (VoD), SMS, or e-mail) offered by IPTV service providers. IPTV Service discovery is the process of discovering them from a request provided through the user's input device (e.g. remote control).
In Cloud computing, cloud providers advertise infrastructure, platform and software services, and the service discovery problem involves the identification of desired cloud service(s) that satisfies the user's requirements such as hosting region, budget, job specifications, etc.
When Web is the service delivery platform, services providers include web sites that advertise their product catalogues, provide shipping services, and in general data and functional services accessible over the web. Here, service discovery is a process to discover the desired web services given a user need.

Rich and formal representations of services and interactions are required for principled selection of services, context-aware analysis and satisfaction of requests, as well as dynamic interaction and negotiation with the service providers. Semantic Web Services (SWS) facilitate specialization and generalization of service needs. Thus, a higher degree of automation and more precise results can be achieved.

A service description includes information about functional properties and non-functional properties. Functional properties which refer to Input, Output, Precondition, and Effect are usually known as IOPE. Input-Out (IO) defines the type of service, and it may do so in either specific or general terms. Quality of Service which is known QoS is an important part of non-functional properties. Functional properties and non-functional properties must be described in a service description language. The service description language defines the “concepts” by which the IO and QoS are described. “Constraints” are conditions that services need to satisfy in order to be valid, and are expressions defined based on the IO or QoS concepts. For example, a shipping company requiring that it can “ship only to Asia” constitutes a constraint. Both the requested service and the advertised services may have constraints.

Several description frameworks have been proposed to meet this demand. In this document, for the sake of example only, we adopt OWL-S as it is the most popular and supported formalisms. Moreover, OWL-S is an open recommendation which can be extended easily to fully support both functional properties and non-functional properties and complex constraints. However, the disclosure herein can readily be adapted to other protocols.

In a service-oriented ecosystem, publishing, binding, and discovering and selecting services are important tasks. Among them, discovering and selecting services are fundamental tasks that involve the processes of finding advertised services satisfying specific requirements and selecting the most suitable services among the service to be found. Many service discovery and selection systems have been proposed to meet the demand. However, the majority of current systems are based on input and output of the requested service and the advertised services. Obviously, these systems have limitations as input and output are only a part of the services. Some systems have included constraints but the constraints which they support are primitive. A few recent systems support QoS matching in addition to IO. These systems also cannot support complex constraints. A system was proposed that attempts to combine IO, Constraints, and QoS matching but it is limited to exact match. Moreover, these systems do not consider ranking of the discovered services. Several service ranking systems have been proposed but they mainly support IO. Some systems discuss QoS but no system focuses on Constraints.

The document “Semantic Matching of Web Services Capabilities”, ISWC 2002 describes I/O matching only.

The document ““A Semantic QoS-Aware Discovery Framework for Web Services”, 2008 IEEE ICWS, describes QoS matching, but not flexibly (i.e. it considers only exact matches), and does not describe IO.

The document “Automated Semantic Web Service Discovery with OWLS-MX”. AAMAS 2006, describes matching based solely on IO, with no handling of constraints or QOS matching.

The present inventors published an article “OWL-S Based Semantic Cloud Service Broker”, ISWC 2012, after the priority date of the present application. This described constraint-matching in the cloud computing domain, but did not consider IO matching or Qos matching.

The article “Requirements for QoS-Based Web Service Description and Discovery” in IEEE TRANSACTIONS ON SERVICES COMPUTING, VOL. 2, NO. 4, OCTOBER-DECEMBER 2009, describes flexible QoS matching, but does not consider I/O, or complex constraints.

The article “A Framework for Dynamic Service Discovery”, the 23rd IEEE/ACM International Conference on Automated Software Engineering (ASE 2008), discloses a framework for web services discovery. It supports IO matching, simple constraint matching, and takes certain account of context and user behavior, but does not support Qos matching.

### SUMMARY OF THE INVENTION

The present invention aims to provide new and useful methods and systems for service discovery and selection.

A first aspect of the present invention is a method for suggesting a plurality of services to a user, the user being associated with a service request S_{R} specified by a request dataset and defining request requirements of a service requested by the user, the request dataset including input-output (IO) data specifying the inputs and outputs of functions describing the requested service, constraint data defining constraints on the requested service, and quality of service (QoS) data defining QoS properties of the requested service, the method using a database of advertised services, each advertised service being associated with a service profile including IO data specifying inputs and outputs of functions describing the advertised service, constraint data defining properties of the advertised service, and QoS data defining QoS properties of the advertised service;
the method including:
(a) a service discovery step of comparing the advertised services with the service request, to determine the degree of matching of the IO data, constraint data and QoS data of the request dataset with the corresponding data of the advertised services, and thereby discover services consistent with at least some portion of the request dataset; and
(b) a service selection step of:
(i) for each discovered service, using the determined degree of matching of at least the constraint data and QoS data of the request dataset and the corresponding data of the discovered service, to form a numerical compliance measure (Sim_{Service}) of the compliance of the discovered service with the request dataset; and
(ii) ranking the discovered services using the numerical compliance measure,
(c) a step of presenting the user with the one or more most-highly ranked discovered services, whereby the user can select one of the discovered services.

The invention makes possible a discovery and selection system to overcome the limitations of the current systems. Preferred embodiments support a unified matching of functional as well as non-functional service properties: input-output, complex constraints, and QoS. Moreover, the system aims to rank the discovered services and then choose the best matched services.

The invention further makes possible a novel service discovery and selection algorithm that can adaptively locate advertised services by performing a flexible matching of the three service properties. The algorithm is preferably capable of returning partially matched services should there be no exact match.

Preferred embodiments of the invention have the following four major contributions:
The system covers all IO, Constraints, and QoS properties of the services and providing requester a manner to express their expected results flexibly.
A novel approach for QoS matching is proposed to match QoS of the advertised service with QoS expectation from requester flexibly.
An atomic constraint is defined as one with only one variable (concept at the lowest level of the ontology hierarchy) and one comparative operation, such as “Packages≦2”. Such a constraint cannot be broken down into simpler constraints. By contrast, a complex constraint is defined as a constraint which is a conjunction of atomic constraints (e.g. Packages≦2 AND Time<5 pm). The system supports matching based on complex constraints as well as matching based on atomic constraints.
The system is able to select the best services from the discovered services based on a service ranking algorithm by computing a combination of scores based on the semantic matching levels.

Another important aspect of the invention it preferably includes ranking the advertised services using uses-specific data, such as user profile, context data (describing the context in which the service request was sent to the system, e.g. from which country) and parameters extracted from user behavior.

The invention may be expressed as a method, or as a computer system (such as a server) for performing the method, or as program instructions (software) stored in non-transitory form for performance by a computer system to cause the computer system to perform the method.

### BRIEF DESCRIPTION OF THE DRAWINGS

An embodiment of the invention will now be described for the sake of example only with reference to the following figures, in which:

FIG. 1 illustrates part of an ontology for use in the embodiment of the invention, specifically the ontology relating to “American city”;

FIG. 2 illustrates five types of concept matching recognized by the embodiment;

FIG. 3 illustrates the overall structure of the embodiment;

FIG. 4 operation of an embodiment using the SWRL language;

FIG. 5 illustrates a QoS ontology used by the embodiment; and

FIG. 6 illustrates in more detail part of the system of FIG. 3.

### DETAILED DESCRIPTION OF THE EMBODIMENT

### 1. Problem Statement and Formalization

1.1 Problem Statement Given a large advertised services in a repository, service discovery and selection is a process to locate or search for a suitable advertised services that satisfy a requester's requirement. Service discovery and selection systems are based on input and output. Real-life services comprise complex constraints (in terms of pre-conditions and post-conditions), and QoS properties which must be tackled in the discovery process.

### 1.1.1 Constraint Problem

As discussed earlier, current discovery and selection systems do not adequately support complex constraints which are usually required in real world applications. This limitation is caused by the current description languages which are often not expressive enough to support advanced service descriptions that involve complex constraints.

For example, consider a shipping scenario where a shipping provider offers a service to ship a package from one place to another place. The service provider may have several constraints on its service as follows: (1) Ships to Africa, North America, Europe, and Asia; (2) Only packages weighing 50 lbs or less are shipped; and (3) If the collected time is before 6 pm, then the shipping duration will be less than a day. Of these, the first constraint can be described in the standard ontology modeling the services. However, this is not true for the second and the third constraints as the current ontology languages do not support such complex constraints. Similarly, the service requester may have similar sophisticated constraints in the requests. So as to model real world scenarios, it is important to support such constraint descriptions in current description languages. Subsequently, the service discovery system must support matching service providers and requester dynamically based on these constraints.

### 1.1.2 QoS Properties

After the discovery process, services that meet requesters' functional requirements must be able to be located dynamically from a large and constantly changing number of service providers based on their Quality of Service (QoS). As a result, using QoS criteria for service selection has been an attracting topic. However, most existing approaches only address some generic dimensions such as price, execution duration, availability and reliability. Such generic criteria are insufficient in some applications. Thus, QoS model should be extensible. Moreover, most of the current approaches rely on service providers to advertise their QoS information, which is subject to the providers. Obviously, providers may advertise their QoS information in a biased way which is beneficial to them. The embodiment uses a QoS model which is extensible, and QoS information can be advertised by providers, computed based on execution monitoring by the users, or collected via user feedback, depending on the characteristics of each QoS criteria.

### 1.1.3 Semantic Matchmaking

It would be desirable for Service matching to be more than just Exact or Fail. More fine-grained matching types such as Subsume, Invert-subsume and Partial are preferred. While strategies to compute these for simple Input-Output service matching situations are available, it is not obvious to extend to more sophisticated scenarios, e.g. involving complex constraints and QoS.

### 1.1.4 Context-Awareness and Adaptation

Service selection would preferably consider not only the matching scores but also the user's context, personal profile, implicit preferences, etc to provide the best services. Though explicit information such as user profile and context are easy to exploit, extracting implicit user preferences is non-trivial. It involves analyzing the recent history of service invocations and mining for statistically significant patterns in the user behavior, and making use of it in scoring services together with other parameters.

### 1.2 Formalization

The embodiment assumes an ontology representation, i.e. the service requests and advertised services are described using service ontologies and domain ontologies. The embodiment is explained using OWL-S ontology formalism which is based on the W3C recommended OWL language. OWL-S is a service description ontology based on the W3C standard Web Ontology Language (OWL). It comprises three main parts: Service Profile, which is for advertising and discovering service capabilities; Service Process, which gives a detailed description of a service's operation; and Service Grounding, which provides details on how to interoperate with a service, via messages. Generally speaking, the OWL-S Service Profile provides both the functional and non-functional information needed for an agent to discover a service, while the OWL-S Service Process and OWL-S Service Grounding, taken together, provide enough information for an agent to make use of a service, once found. In discovery of services, the embodiment uses the OWL-S Service Profile.

### Example 1

(Shipping Service Scenario): Consider a scenario where several advertised shipping services offer to ship packages from one City to another City. A service requester (‘user’) is interested to find the best shipment service offer, taking into consideration constraints, e.g. weight and location. Suppose there are five advertised shipping services namely, S₁, S₂, S₃, S₄, and S₅. A service request Sᵣ intends to discover the most suitable advertised shipping service that best satisfies its shipping requirements. For illustration, we are interested in the weight of the package, the City where the package is shipped to, and be able to meet QoS criteria including time, cost, reliability, and availability of the services. In short, a service specification has the following information.
Weight range of the package=[the smallest weight, the biggest weight]. Weights of both requested service and advertised service are assumed to be in ranges. Weights for advertised services are in ranges since these services can offer to ship packages with different weights. Weights for requested services are also in ranges since the requested service may want to ship different packages with different weights to the same location with the same QoS.
To City: The City that the package is shipped to. In this illustration, we assume that the City could be: American City, North American City, East American City, and New York. When we say a service can ship to the American City, North American City, or East American City, it means that it can ship to all the Cities which belong to that City area.
QoS: {time, cost, reliability, and availability}. QoS criteria are assumed to be measured in some standard units. The values of these criteria are also can be in ranges, but for illustration, in the following example we only use single values.

The following are the descriptions of five advertised services:

### Provider S₁:

Weight of the package=[30,50]
To City: North American City
QoS: {3,3,3,3}

### Provider S₂:

Weight of the package=[10,100]
To City: North American City
QoS: {2,2,4,4}

### Provider S₃:

Weight of the package=[35,45]
To City: New York
QoS: {2,2,4,4}

### Provider S₄:

Weight of the package=[20,40]
To City: East American City
QoS: {4,2,3,3}

### Provider S₅:

Weight of the package=[10,20]
To City: East American City
QoS: {4,2,3,3}
   Requested service Sᵣ:
Weight of the package=[30,50]
To City: New York
QoS: {3,3,3,3}

Definition 1 (Input/Output): An input ‘in_{S}’ (or an output ‘out_{S}’) of a service S is a variable which represents a required parameter to execute the service (or a result of the execution). These variables are associated with ontology classes. Input i (or output)) of a service S is denoted as in(i)_{S} (or out(J)_{S}). A service includes a set of input IN_{S} (∀i,in(i)_{S}εIN_{S}) and a set of output OUT_{S} (∀i, out(j))_{S}εOUT_{S}).

### Example 2

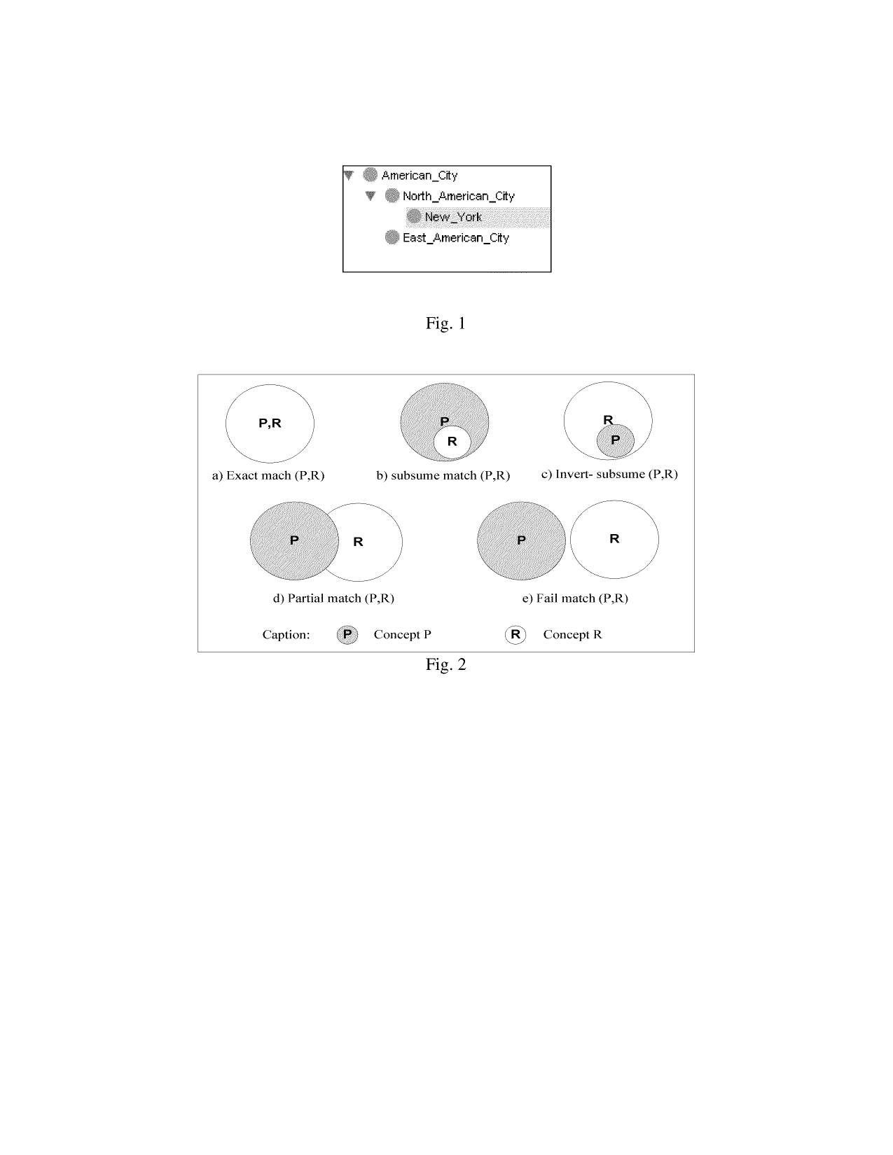

(Input/output): With the services described in the shipping scenario in Example 1, input and output of the services are:
Input: the City where the package is shipped to. This is represented by a concept in the ‘American City’ ontology, which is illustrated in FIG. 1.
Output: The output confirms if the package is shipped. This is represented by a ‘Confirmation’ concept in a ‘Shipping’ ontology.

By designing the American City ontology as in FIG. 1, when saying a service that can ship to ‘American City’, it means that the service can ship to all the Cities in ‘American City’, which includes New York. Similarly, when saying that a service that can ship to ‘North American City’ or ‘ East American City’, it means that this service can ship to all the Cities in ‘North American City’ or ‘ East American City’, respectively.

Hence, we have five advertised shipping with input and output:
S₁(In: North American City; Out: Confirmation)
S₂(In: North American City; Out: Confirmation)
S₃(In: New York; Out: Confirmation)
S₄(In: East American City; Out: Confirmation)
S₅(In: East American City; Out: Confirmation)
   and requested shipping service Sᵣ:
Sr(In: New York; Out: Confirmation)

Definition 2 (Concept Matching):

Concept matching between a concept C_{R} and a concept C_{P} defines a term representing how similar between the two concepts is. It takes the values Exact match, Subsume match, Invert-Subsume match, Partial match, and Fail match. These Jive values are illustrated in FIG. 2. Note that a concept A is called “super class” of concept B in the ontological hierarchy if A is a parent (ancestor) of B. Concept A is called a “direct” super class of concept B in the ontological hierarchy if concept A is a parent of concept B and concept A is one level above B (for example, in FIG. 5, “QoS Business” is a direct super class of “Cost”), and Concept A is called a “non-direct” super classes of Concept B in the ontological hierarchy if A is a parent of B and A is more than one level above B (for example in FIG. 5, “QoS Measurement” is an non-direct super class of “Response”).
Exact match (C_{R}, C_{P}): two concepts C_{R} and C_{P} are called ‘Exact match’ if the two concepts are semantically equivalent. In this case, the two concepts refer to a concept in an ontology or two different concepts in an ontology but having the ‘same as’ relation. This is the most accurate match.
Subsumes match (C_{R}, C_{P}): Concept C_{R} is called ‘Subsumes match’ with concept C_{P} if C_{P} is a super class of concept C_{R}. Concept C_{R} is called ‘Subsumes match’ with concept C_{P} if C_{P} is a direct super class or an indirect super class of concept C_{R}. In this case, concept C_{P} is more generic than concept C_{R}. This matching is less accurate than exact match.
Invert-Subsumes match (C_{R}, C_{P}): Concept C_{R} is called ‘Invert-Subsumes match’ with concept C_{P} if C_{R} is a super class (direct or non-direct super class) of concept C_{P}. In this case, concept C_{R} is more generic than concept C_{P}. This is an invert-case of the subsume case.
Partial match (C_{R}, C_{P}): Concept C_{R} is called ‘Partial match’ with concept C_{P} if C_{R} and G are in the same ontology but sharing one or some super concepts (in other words if one or more concepts exist which are super classes of both C_{P} and C_{R}) and C_{R} and C_{P} do not have ‘disjoint’ relation.
Fail match (C_{R}, C_{P}): Concept C_{R} is called ‘Fail match’ if they are not classified in the above cases. This usually happens when the two concepts are in different ontologies or two concepts are in the same ontology but they do not share any super concept.

### Example 3

(Concept Matching): The similarity values Exact match, Subsume match, Invert-Subsume match, Partial match, and Fail match are illustrated as follows with concepts in ‘American City’ ontology. This is also input matching between requested service Sᵣ and advertised services Sᵢ(i= 1̅,̅5̅).
Exact match (New York, N.Y.): The two concepts are identical.
Subsumes match (New York, North American City): Similarity between concepts North American City and New York is subsumed since North American City is super concept of concept New York. It means that the advertised service can ship to all the Cities of American consisting of New York while the requested service only need to ship to New York. This is similar with the similarity between the pair (American City, North American City) and the pair (American City, East American City).
Invert-Subsumes match (North American City, New York): Similarity between New York and North American City is Invert-Subsumes match since New York is a sub concept of North American City. It means that the requested service wishes to ship package to Cities in North American City including New York but the advertised service can only ship to New York. This is similar with the similarity between the pair (North American City, American City) and the pair (East American City, American City).
Partial match (New York, East American City): Similarity between concept New York and concept East American City is Partial match since they share the same root (American City). In this case, the two concepts share similar properties which are inherited from concept American City. This similarity is similar to the pair (North American City, East American City) since they match in some common Cities in the North East American.
Fail match (New York, Confirmation): Similarity between concepts New York and

Confirmation is fail as the two concepts are from different ontologies (‘American City’ ontology and ‘Shipping’ ontology) and has no relation.

Definition 3 (Constraint): Let x be a service attribute and y₀,y₁, and y₂ are its possible values. A constraint of a service S, c(.,.) belongs to one of the following classes:
Atomic=: c(x,y₀): x=y₀
Atomic>: c(x,y₁): x≧y₁
Atomic<: c(x,y₂): x≦y₂
Conjunction: c(x,y)=A= [symbol] _{i=1, . . . n} cᵢ(xᵢ,yᵢ), where cᵢ(.,.) is an atomic constraint and the symbol “ [symbol] ” is used to mean “AND”. c(x,y) is referred to as a complex constraint, in that it is defined based on more than one atomic constraints, and is met if and only if all of the atomic constraints are met.

Below we define a matching strategy for arriving at a semantic matching of atomic constraints.

Definition 4 (Constraint Matching Strategy): Let c_{R}(x_{R},y_{R})εC_{R} and c_{P}(x_{P},y_{P})εC_{P} be two atomic constraints. A constraint defines a term representing how c_{P} satisfies c_{R}. Constraint matching is defined as:
Exact match: constraint c_{P} is called ‘exact match’ with constraint c_{R} if and only if:

(c_{R}εAtomic) [symbol] (c_{P}εAtomic=) [symbol] (y_{R}=y_{P})
Subsume match: constraint c_{P} is called ‘subsume matching’ with constraint c_{R} if and only if:

(c_{R}εAtomic= [symbol] c_{R}εAtomic>) [symbol] (c_{P}εAtomic>) [symbol] (y_{P}≦y_{R})

[symbol]

(c_{R}εAtomic= [symbol] c_{R}εAtomic<) [symbol] (c_{P}εAtomic<) [symbol] (y_{R}≦y_{P})

[symbol]

(c_{R}εAtomic>) [symbol] (c_{P}εAtomic) [symbol] (y_{P}≦y_{R})

[symbol]

(c_{R}εAtomic<) [symbol] (c_{P}εAtomic) [symbol] (y_{R}≦y_{P})
The symbol “ [symbol] ” is used to mean “OR”.
Invert-subsume match: constraint c_{P} is called ‘invert-subsume match’ with constraint c_{R} if and only if:

(c_{R}εAtomic= [symbol] c_{R}εAtomic>) [symbol] (c_{P}εAtomic>) [symbol] (y_{R}≦y_{P})

[symbol]

(c_{R}εAtomic= [symbol] c_{R}εAtomic<) [symbol] (c_{P}εAtomic<) [symbol] (y_{P}≦y_{R})

[symbol]

(c_{R}εAtomic>) [symbol] (c_{P}εAtomic=) [symbol] (y_{R}≦y_{P})

[symbol]

(c_{R}εAtomic<) [symbol] (C_{P}εAtomic=) [symbol] (y_{P}≦y_{R})
Partial match: constraint c_{P} is called ‘Partial match’ with constraint c_{R} if and only if:

(c_{R}εAtomic<) [symbol] (c_{P}εAtomic>) [symbol] (y_{P}≦y_{R})

[symbol]

(c_{R}εAtomic>) [symbol] (c_{P}εAtomic<) [symbol] (y_{R}≦y_{P})
Fail match: constraint c_{P} is failed to match with constraint c_{R} if they are not categorized in the above matches.

### Example 4

(Constraint matching): Consider the advertised services described in Example 1 with different constraints on weight:
S₁: can ship only packages in which the weight is from 30 kg to 50 kg.
S₂: can ship only packages in which the weight is from 10 kg to 100 kg.
S₃: can ship only packages in which the weight is above 35 kg to 45 kg.
S₄: can ship only packages in which the weight is above 20 kg to 40 kg.
S₅: can ship only packages in which the weight is above 10 kg to 20 kg.

And the requested service Sᵣ with constraints on the weight.
Sᵣ: wants to ship packages in which the weight is from 30 kg to 50 kg

The results of constraints matching are illustrated follows:
Exact match(Sᵣ, S₁): Both the services can ship packages in which the weight is from 30 kg to 50 kg
Subsume match(Sᵣ, S₂): The ranges of weight that S₂ offers includes the ranges of weight Sᵣ asks.
Invert subsume(Sᵣ, S₃): The ranges that Sᵣ asks including the ranges that S₃ offers
Partial match(Sᵣ, S₄): Both the services have common parts: supporting packages for which the weight is from 30 kg to 40 kg
Fail match(Sᵣ, S₅): S₅ cannot ship any packages that are requested by Sᵣ

Definition 5 (QoS): QoS is a set of criteria determining the quality of the service showing the degree of satisfaction by users using the service. Let qᵢ₁, qᵢ₂, . . . , qᵢₘ be a set of criteria of service S. QoS of S is defined as:

QoS(S)={qᵢ₁, qᵢ₂, . . . , qᵢₘ}

Criteria of QoS can be classified by Pos or Neg sets. Pos set includes positive criteria in which the higher value, the better the service. Neg set includes negative criteria in which the higher value, the worse the service.

QoS of a requested service is represented as the following with q₁, q₂, . . . , qₘ denoting the expected values of the criteria:

QoS(R)={q₁, q₂, . . . , qₘ}

QoS of a advertised service is represented as the following with q′₁,q′₂, q′ₘ denoting the offered values of the criteria:

QoS(P)={q′₁, q′₂, . . . , q′ₘ}

Definition 6 (QoS Matching): QoS Matching between a service R and a service P defines a term representing how QoS of service P satisfies QoS of service R. It takes values Exact match, Subsume match, Invert-Subsume match, Partial match, and Fail match.
Exact match: Service P is called ‘exact match’ with service R if and only if

(∀qᵢεQoS(R),∃q′ᵢεQoS(P):qᵢ=q′ᵢ) [symbol] (∀q′ᵢεQoS(P),∃qᵢεQoS(R):qᵢ=q′ᵢ)
Subsume match: Service P is called ‘subsume match’ with Service R if and only if:

((qᵢεQoS(R),q′ᵢQoS(P):qᵢ≦q′ᵢ)

[symbol]

((qᵢ,q′ᵢ)εPos(QoS)) [symbol] ((∀qᵢεQoS(R),∃q′ᵢQoS(P):q′ᵢ≦qᵢ) [symbol] (qᵢ,q′ᵢ)εNeg(QoS))
Invert-Subsume match: Service P is called ‘invert-subsume match’ with Service R if and only if:

((qᵢεQoS(R),∃q′ᵢεQoS(P):q′ᵢ≦qᵢ) [symbol] ((qᵢ,q′ᵢ)εPos(QoS))

[symbol]

((∀qᵢεQoS(R),∃q′ᵢQoS(P):qᵢ≦q′ᵢ) [symbol] (qᵢ,q′ᵢ)εNeg(QoS))
Partial match: Service P is called ‘Partial match’ with service R if and only if they are not Exact match, Subsume match, Invert-Subsume match and

(∃qᵢεQoS(R),∃q′ᵢεQoS(P):qᵢ=q′ᵢ)
Fail match: service P fails to match with service R if they are not categorized in the above matches.

### Example 5

(QoS Matching): We consider services with the following QoS criteria: time, cost, reliability, and availability. Hence, QoS(S)={time, cost, reliability, and availability}. QoS of the service in Example 1 as follows:
QoS(S₁)={3,3,3,3}
QoS(S₂)=QoS(S₃)={2,2,4,4}
QoS(S₄)=QoS(S₅)={4,2,2,4}

And a requested service Sᵣ with QoS(Sᵣ)={3,3,3,3}.

QoS matching between the requested service Sᵣ and the respective Sᵢ(i= 1̅,̅5̅) is as follows:
EXactmatch(Sᵣ,S₁): The criteria are exactly the same.
Subsumematch(Sᵣ,S₂): Time and cost are negative criteria, so the lesser the values, the better the QoS. Conversely, for reliability, and availability, the greater values, the better QoS. This match is similar to the pair (Sᵣ,S₃) since QoS(S₂)=QoS(S₃).
Partialmatch(Sᵣ,S₄): Two criteria are satisfied (cost and availability) and the two other criteria are not satisfied (time, reliability). This match is similar to the pair (SᵣS₅) since QoS(S₄) QoS(S₅).

Definition 6 (Service): Given IN_{S} is a set of input and OUT_{S} is a set of output of service S. C_{S} is an optional set of constraints and QoS_{S} is an optional quality of the service. Service S is represented as follows:

S_{S}=(IN_{S},OUT_{S},C_{S},QoS_{S})

With the definition, a requested service is represented as:

S_{R}=(IN_{R},OUT_{R},C_{R},QoS_{R})

And an advertised service is represented as:

S_{P}=(IN_{P},OUT_{P},C_{P},QoS_{P})

Definition 7 (Service Matching): Matching between a service request S_{R} and a published service S_{P} can be any of the following Jive types:
Exact match: S_{R} exactly matches with S_{P} in all of IN, OUT, C, and QoS.
Subsume match: S_{R} matches with S_{P} such that S_{P} IN_{R} c IN_{P}, OUT_{P} c OUT_{R}, C_{P} implies C_{R}, and QoS_{P}⊂QoS_{R}.
Invert-subsume match: S_{R} matches with S_{P} such that S_{P} IN_{P}⊂IN_{R}, OUT_{R}⊂OUT_{P}, C_{R} implies C_{P}, and QoS_{R}⊂QoS_{P}.
Partial match: S_{R} partially matches with S_{P} such that the match is not subsume or invert-subsume
Fail match: if the match cannot be categorized under the above four matches.

Definition 8 (Semantic Matching Partial Order): Let Y be a list (Exact, Subsume, Invert-Subsume, Partial, Fail). We define a partial order on Y such that: Exact match>>Subsume match>>Invert-Subsume match>>Partial match>>Fail match.

By Definition 8, the embodiment can optionally let the user specify a lower bound on the desired service matching, and require that all services matching at least this type be returned. For instance, if the user desires at least a subsume match, the matched services should be either Exact or Subsume. Later service selection can be invoked to rank them suitably.

Definition 9 (User Preference): User Preference (UP) is a tuple {UP_{IO}, UP_{CON}, UP_{QoS}}, where the tuple values respectively specify the lower bound on semantic matching required for input, output, constraints and QoS. UP_{IO}, UP_{CON}, UP_{QoS}ε{Exact, Subsume, Invert-subsume, Partial, Fail}

UP is understood to be a parameter available during the entire service discovery pipeline.

Definition 10 (Service discovery): Given a service request SR=(INR, OUTR, CR, QoSR) and user preference UP. Service Discovery is a process to identify all SP=(INP, OUTP, CP, QoSP) such that.
(∀IN_{P}, ∃IN_{R}: ConceptMatching(IN_{P},IN_{R}))≧UP_{IN}) [symbol] (∀OUT_{R}, ∃OUT_{P}: ConceptMatching (OUT_{P},OUT_{R}))≧UP_{OUT})
(∀C_{R}, ∃C_{P}: ConstraintMatching(C_{R},C_{P})) [symbol] (∀C_{P}, ∃C_{R}: ConstraintMatching(C_{P},C_{R})))
QoSMatching(QoS(R),QoS(P))≧UP_{QoS}

### Example 6

(Service discovery): Assume that advertised service repository ResP of the embodiment is includes five services S₁, S₂, S₃, S₄, and S₅ as mentioned in Example 1. A requester wishes to search for provided services that satisfy that requirement Sᵣ. Moreover, the requester also wishes to filter the results in that he/she only wants the advertised services that match the request Inver-Subsume, so UP=Inver-Subsume. The matching occurs as follows and the matching results of IO, Constraints, and QoS are used from Example 3, Example 4, and Example 5, respectively:

For S₁:
IO matching: Exact match
Constraint matching: Exact match
QoS matching: Exact match
[symbol] Service matching: Exact match

For S₂:
IO matching: Subsume match
Constraint matching: Subsume match
QoS matching: Subsume match
[symbol] Service matching: Subsume match

For S₃:
IO matching: Invert-Subsume match
Constraint matching: Invert-Subsume match
QoS matching: Subsume match
[symbol] Service matching: Invert-Subsume match

For S₄:
IO matching: Partial match
Constraint matching: Partial match
QoS matching: Partial match
[symbol] Service matching: Fail match. The result of service matching is ‘Fail match’ because the UP is Invert-Subsume which is greater than Partial match logically.

For S₅:
IO matching: Fail match
Constraint matching: Fail match
QoS matching: Partial match
[symbol] Service matching: Fail match

In short, the advertised services that satisfy user requirements (requested service and UP) are S1, S2, and S3.

Definition 11 (Service Selection): Given a list of D=(S,M), and a tuple T=(UserProfile, UserCon,DLog), where S is a discovered service, M=(M_{IO},M_{CON},M_{Qos}) is a set of matched levels for input, output, constraints, and QoS respectively. UserProfile is a list capturing user's personal information. UserCon is a list capturing user's context information and DLog is a database of service logs. Service selection is a process that outputs a ranked list D* using a scoring mechanism based on M and T.

### 2. System Architecture

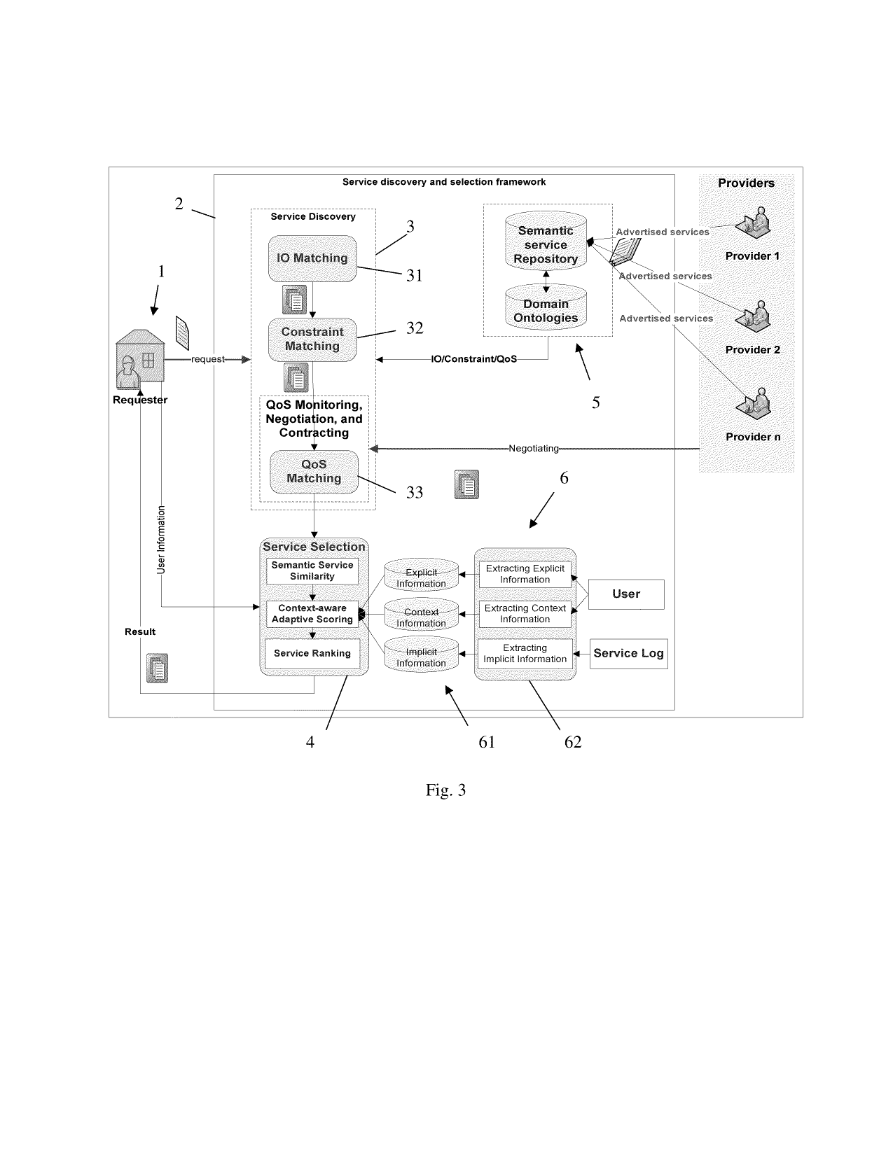

The architecture of the embodiment is illustrated in FIG. 3. A requester 1 sends a request to the embodiment 2. The core of the framework of the embodiment is a service discovery section 3 which includes three layers for discovery services: IO matching 31, Constraint matching 32, and QoS matching 33; and a component 4 for service selection. The results of a previous layer will be the input of the next layer. Particularly, result of IO matching 31 which a set is of advertised services will be the input of Constraint matching layer 32; the output of Constraint matching layer 32 will be the input of QoS matching layer 33. The output of QoS matching 33 is a list of advertised services that satisfied IO, Constraints, and QoS requirements. These services are passed to component 4 to be ranked. The output of component 4, consisting of advertised services are ranked, will be selected and returned to the users.
IO matching 31: Match input and output of requested service against advertised service, respectively.
Constraint matching 32: Resolve constraints of requested service against constraints advertised services and vice versa.
QoS matching 33: Match QoS of advertised services with QoS expectation from requester.
Service selection 4: Choose the best discovered advertised service(s) returned by the above three layers.

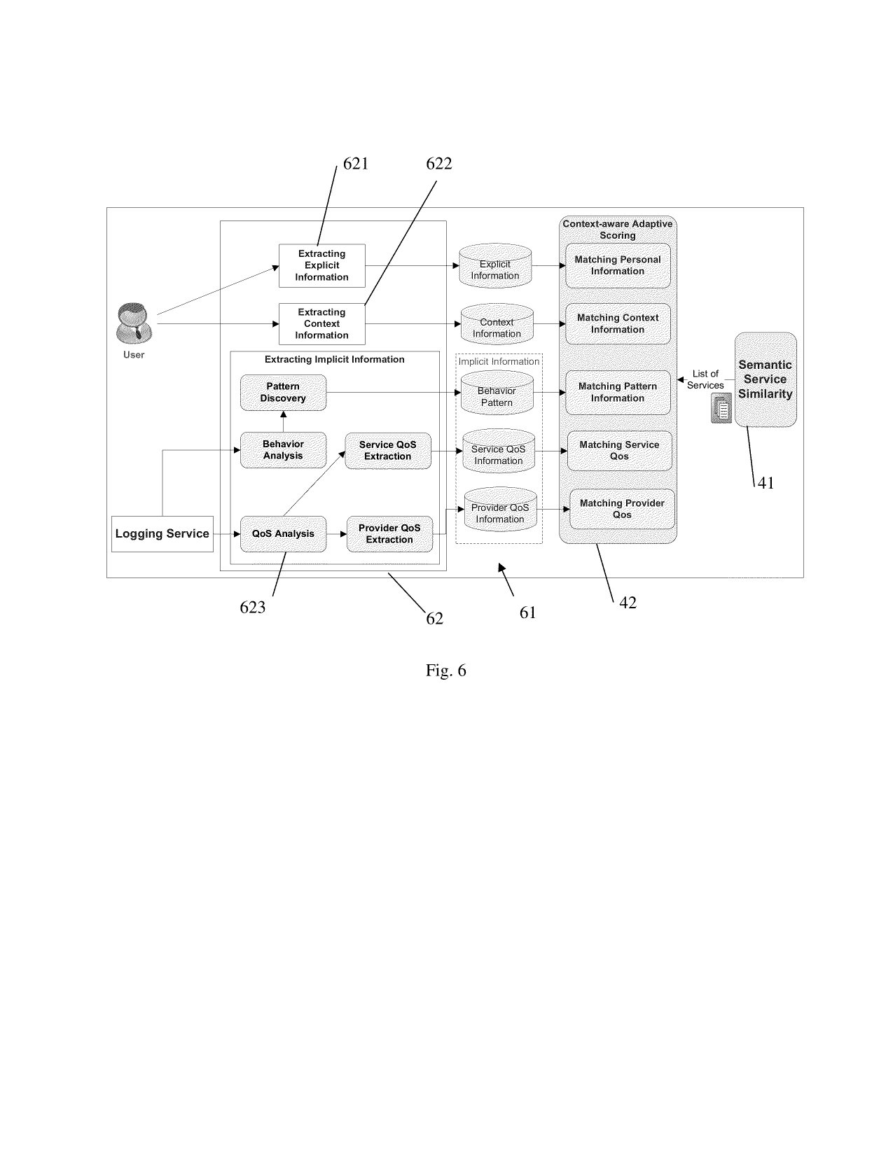

The service selection discovery section 3 makes use of data relating to IO, constraint, and QoS stored in a database 5. This data describes advertised services offered by one or more providers (FIG. 3 shows, for example, three such providers labeled Provider 1, Provider 2 and Provider 3, but there may any number of providers), and supplied by them into the database 5. The database 5 has a first section (“semantic service repository”) which receives this data, and a second section (“domain ontologies”) for storing the data in the ontology format used by the system. A conversion system is provided to transfer data from the semantic service repository to the domain ontology section of the database 5. As described in more detail below with reference to FIG. 6, the service selection component 4 has access to three databases 61: a database of explicit information, a database of context information and a database of implicit information. The contents of the explicit information database and context information database are received directly from one or more users, one of whom is the same person as the Requester. The two databases collectively store the data referred to as UserProfile below. The implicit information is information collected automatically from each user's service log, and the database of implicit information is storing the information referred to as DLog below. The task of populating the databases 61 is performed by a component 62. The operation of the units 4, 61 and 62 is described below in more detail in relation to FIG. 6. The system algorithm is presented in detail in Section 3.

### 3. Service Discovery and Selection Algorithm

### 3.1 Overall Algorithm

The embodiment's discovery and selection algorithm is presented as in Algorithm 1. The algorithm includes three layers which are three filters to select advertised services. The Requester 1 is able to give User Preferences (UP) defined in Section 1 for the IO matching layer 31 and QoS matching layer 33. The UP are typically minimum values for concepts defined in terms of numbers, which must be satisfied for the service to be accepted by a requester. Together the UP define a request dataset, made up of a plurality of concepts.

The algorithm starts with the first matchmaking step IOMatching(R,P) performed by the IO matching layer 31 which matches input and output of the requested service and advertised service, respectively. This matching layer 31 is presented in detail in Section 3.2. Only advertised services satisfying the matching layer 31 will come to the second layer 32.

ConstrainMatching(R,P) is performed the second layer 32 which resolves constraints of advertised services and requested service, respectively. Details of this layer are presented in Section 3.3. Only advertised services satisfying the second layer 32 will come to the third layer 33.

QoS matching is performed by the third layer 33 which compares QoS value of the advertised service with QoS expectation of the requested service. This layer is presented in detail in Section 3.4. Advertised services which satisfy QoS Matching will be returned to the requester. The last component 4, which performed Service Selection, will be presented in Section 3.5.

Algorithm 1 ServiceDiscoverySelection: Search for advertised
services P in repository ResP that satisfy a given request R;
return a set of advertised services satisfying the request R

| | |
|---|---|
| 1: | function ServiceDiscoverySelection(Request |

| | |
|---|---|
| 2: | R, Repository ResP) |

| | |
|---|---|
| 3: | result_{IO} = Θ |
| 4: | result_{Con} = Θ |
| 5: | resultQoS = Θ |
| 6: | result = Θ |
| 7: | // Performing IO matching |
| 8: | for all P ∈ ResP |

| | |
|---|---|
| 9: | if IOMatching(R, P) then |

| | |
|---|---|
| 10: | result_{IO}:= result_{IO} ∪ P |

| | |
|---|---|
| 11: | end if |

| | |
|---|---|
| 12: | end for |
| 13: | // Constraint matching |
| 14: | ResP = result_{IO} |
| 15: | for all P∈ ResP |

| | |
|---|---|
| 16: | if ConstraintMatching(R,P) then |

| | |
|---|---|
| 17: | result_{Con}:= result_{Con} ∪ P |

| | |
|---|---|
| 18: | end if |

| | |
|---|---|
| 19: | end for |
| 20: | // QoS matching |
| 21: | ResP = result_{Con} |
| 22: | for all P ∈ ResP |

| | |
|---|---|
| 23: | if QoSMatching(R,P) then |

| | |
|---|---|
| 24: | result_{QoS}:= result_{QoS} ∪ P |

| | |
|---|---|
| 25: | end if |

| | |
|---|---|
| 26: | end for |
| 27: | result = ServiceSelection(result_{QoS}) |
| 28: | return result |

end function

### 3.2 IO Matching Layer

### 3.2.1 IO Matching Description

IO matching is a process to check if inputs and outputs of an advertised service are matched against inputs and outputs of a requested service, respectively. In input matching, we consider how inputs of requested service satisfy inputs of advertised service as inputs of the advertised services are more important to the provider. The service can be invoked only if inputs of the advertised services are satisfied. On the other hand, in output matching, we consider how outputs of advertised services satisfy outputs of requested service as outputs are more important to the requesters. Input and output of a service are concepts in ontologies. Input matching (or output matching) is a process to compute the semantic matching between concepts representing inputs (or output) of requested service and inputs (or output) of advertised services. The Semantic Matching could be Exact match, Subsume match, Invert-subsume match, Partial match, and Fail match as introduced in Definition 2 (Section 2).

### 3.2.2 IO Matching Algorithm

Algorithm 2 illustrates how IO matching occurs. We use two flags: flagIN and flagOUT. FlagIN is used to check for every input of advertised service must be satisfied by at least an input of a requested service. If this condition is satisfied, FlagIN will have a value TRUE; Otherwise, it has a value FALSE. Similarly, FlagOUT is used to check for every output of requested service must be satisfied by at least an output of a advertised service. If this condition is satisfied, FlagOUT will have a value TRUE; otherwise, it has a value FALSE.

Algorithm 2 (IOMatching): Check if inputs and outputs of advertised
services are matched against inputs and outputs of requested
service with given User Preferences UP.IN and UP.OUT; return
TRUE if they are matched, otherwise return FALSE

| | |
|---|---|
| 1: | function IOMatching(Request R, Advertise |

| | |
|---|---|
| 2: | service P) |

| | |
|---|---|
| 3: | // Inputs Matching |
| 4: | for all in_{P} ∈ IN_{P} |

| | |
|---|---|
| 5: | flagIN = FALSE |
| 6: | for all in_{R} ∈ IN_{R} |

| | |
|---|---|
| 7: | if ConceptMatching(in_{P},in_{R})≧UP.IN the |

| | |
|---|---|
| 8: | flagIN = TRUE |

| | |
|---|---|
| 9: | end if |

| | |
|---|---|
| 10: | end for |
| 11: | if !flagIN then |

| | |
|---|---|
| 12: | return FALSE |

| | |
|---|---|
| 13: | end if |

| | |
|---|---|
| 14: | end for |

15:

| | |
|---|---|
| 16: | // Outputs Matching |
| 17: | for all out_{R} ∈ OUT_{R} |

| | |
|---|---|
| 18: | flagOUT = FALSE |
| 19: | for all out_{P} ∈ Out_{P} |

| | |
|---|---|
| 20: | if ConceptMatching(out_{R},out_{P})≧UP.OU′ |

| | |
|---|---|
| 21: | then flagOUT = TRUE |

| | |
|---|---|
| 22: | end if |

| | |
|---|---|
| 23: | end for |
| 24: | if !flagOUT then |

| | |
|---|---|
| 25: | return FALSE |

| | |
|---|---|
| 26: | end if |

| | |
|---|---|
| 27: | end for |

| | |
|---|---|
| 28: | return TRUE |

| | |
|---|---|
| 29: | end function |

IOMatching is the first layer 31 of the system algorithm. After IOMatching, only advertised services have Similarity Matching greater than UP.IN for input and UP.OUT for output are returned. The results are used for the next layer: constraint matching.

### 3.3 Constraint Matching Layer

### 3.3.1 Modeling Constraints

OWL-S provides a generic way of representing condition expressions in Web services. A description is given at http://www.ai.sri.com/daml/services/owl-s/1.2/generic/Expression.owl. It supports six languages and logics including SWRL, SWRL-FOL, DRS, KIF, SPARQL and RDQL and can be easily extended to support other logic expressions. However, reasoning support over logic expressions embedded in OWL-S is limited. In this paper, we take a different approach whereby we model the pre-conditions and post-conditions as constraints in the domain ontology. As proof of concept, we adopt SWRL to model the constraints.

SWRL is a proposal for a Semantic Web rules-language, combining sub-languages of the OWL Web Ontology Language (OWL DL and Lite) with those of the Rule Markup Language. Therefore, SWRL uses OWL axioms and enables Horn-like rules to be combined with an OWL knowledge base. SWRL rules are written as pairs of antecedent and consequent. The antecedent is referred to as the body while the consequent is referred to as the head. The body and head include a conjunction of one or more atoms. Multiple atoms are considered as a conjunction. Rules with conjunctive consequents could be changed into multiple rules each with an atomic consequent. A rule expresses the following meaning: whenever the conditions specified in the antecedent hold, then the conditions specified in the consequent must also hold.

The syntax for SWRL extends the abstract syntax of OWL which is not “human readable”. Therefore, in the following discussions, the rules will be given in a relatively informal “human readable” form similar to that used in many published works on rules. A rule, in this syntax, has the form: “antecedent [symbol] consequent” where both antecedent and consequent are conjunctions of atoms written a1 [symbol] . . . [symbol] an.

Variables are indicated using the standard convention of prefixing them with a question mark (e.g., ?x). For examples, using this syntax, a rule asserting that the composition of parent and brother properties implies the uncle property would be written as: “parent(?x; ?y)̂brother(?y; ?z) [symbol] uncle(?x; ?z)”.

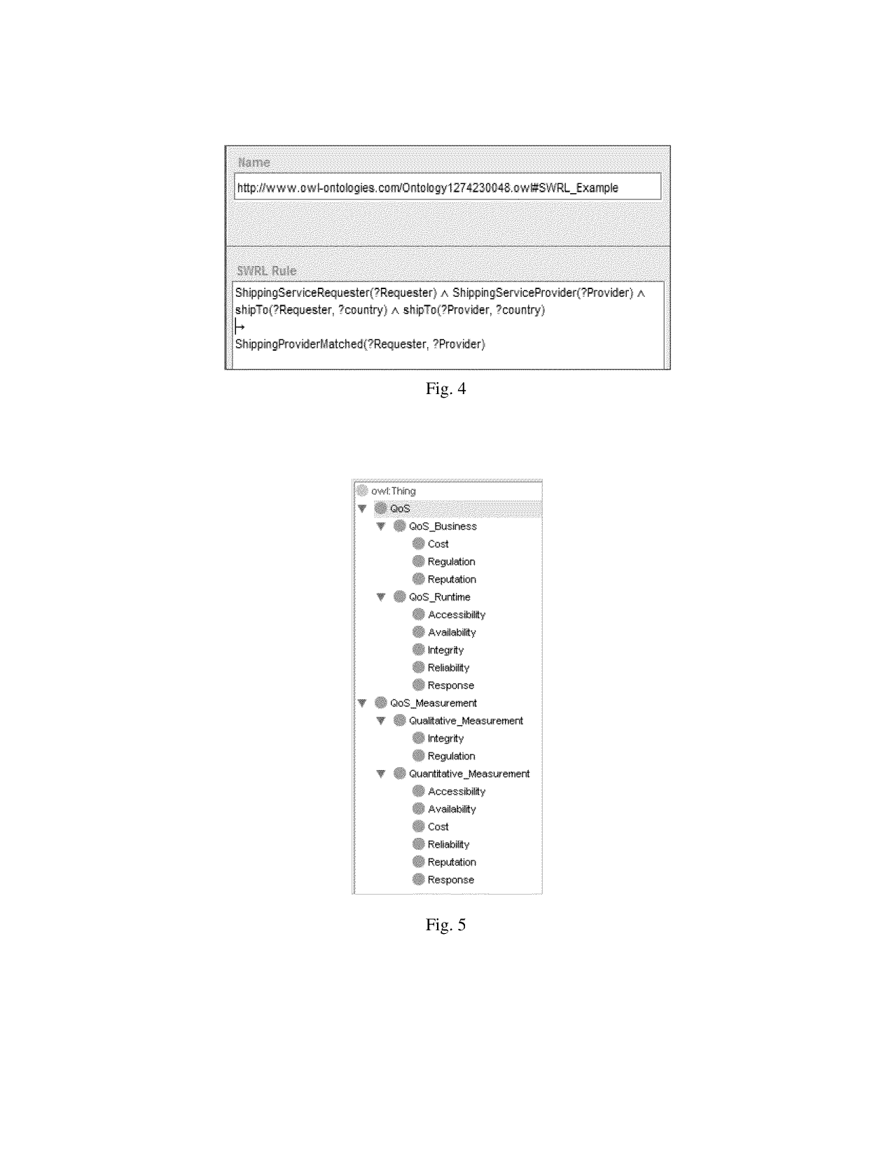

For example, a SWRL rule expressing that if the shipping requester expects to ship a package to the shipping provider residing in the same country then the provider can satisfy the requester is depicted in FIG. 4. Executing this rule would have the effect of setting the ShippingProviderMatched property to Provider in the individual that satisfies the rule, named Requester.

### 3.3.2 Algorithm for Constraints Matching

Algorithm 3 (ConstraintMatching): Comparing constraint similarity
between a advertised service and a requested service with
UP.CON which is user expectation. Return TRUE if the similarity
is greater than UP.CON; Otherwise return FALSE.

| | |
|---|---|
| 1: | function ConstraintMatching (R, P) |

| | |
|---|---|
| 2: | // decompose Type3 constraints |
| 3: | for all c(x,y) ∈ C_{R} |

if c is Type3 then

| | |
|---|---|
| 4: | decompose(c,C_{R}) |

| | |
|---|---|
| 5: | end if |

| | |
|---|---|
| 6: | end for |
| 7: | for all c′(x′,y′) ∈ C_{P} |

| | |
|---|---|
| 8: | if c′ is Type3 then |

decompose(c′,C_{P})

| | |
|---|---|
| 9: | end if |

| | |
|---|---|
| 10: | end for |

11:

| | |
|---|---|
| 12: | //Checking if C_{P} satisfies C_{R} |
| 13: | for all c ∈ C_{R} |

| | |
|---|---|
| 14: | flagC = FALSE |
| | for all c′ ∈ C_{P} |

| | |
|---|---|
| 15: | if AtomicConstraintMatching(c,c′) ≧ UP.CON then |

| | |
|---|---|
| 16: | flagC = TRUE |

| | |
|---|---|
| 17: | end if |

| | |
|---|---|
| | end for |
| 18: | if !flagC then |

| | |
|---|---|
| 19: | return FALSE |

| | |
|---|---|
| 20: | end if |

| | |
|---|---|
| 21: | end for |
| 22: | //Checking if C_{R} satisfies C_{P} |
| 23: | for all c′ ∈ C_{P} |

| | |
|---|---|
| 24: | flagC′ = FALSE |
| 25: | for all c ∈ C_{R} |

| | |
|---|---|
| 26: | if AtomicConstraintMatching(c′,c) ≧ UP.CON then |

flagC′ = TRUE

| | |
|---|---|
| 27: | end if |

| | |
|---|---|
| 28: | end for |
| 29: | if !flagC′ then |

| | |
|---|---|
| 30: | return FALSE |

| | |
|---|---|
| 31: | end if |

end for
return TRUE

end function

Algorithm 3 presents constraint matching algorithm between constraints of requested service and constraints of advertised service. The algorithm first decomposes Type3 constraints of both services P and R into atomic constraints as only atomic constraints can be measured similarity. From there, C_{R} and C_{P} only contain atomic constraints. Next, the algorithm checks if C_{R} satisfies C_{P} and vice verse with a User Reference UP.CON. This is done by using AtomicConstraintMatching which is Definition 4 (Section 2).

Constraint matching is the second phase of the discovery system. The results of this layer 32, which is a set of advertised services satisfying the requirement, will be used as a repository input for the final matching layer. QoS matching, which is the final matching layer 33, is as follows.

### 3.4 QoS Matching Layer

### 3.4.1 QoS Criteria

We describe our the embodiment's QoS matching algorithm through a proof-of-concept QoS model. FIG. 5 represents a sample QoS ontology with different criteria and relationship. The ontology was created based on different QoS criteria discussed by existing work. QoS includes two types namely, QoS Business and QoS Runtime. QoS Business refers to the measurement of criteria from a business perspective. QoS Runtime refers to the measurement of criteria that are related to the execution of a service. QoS can be classified in a different manner based on its Qualitative and Quantitative measurement.

QoS criteria are measurements via a Monitoring process. Depending on particular criteria, the embodiment may use different techniques of monitoring. The techniques are message interception, probing, value collection, and user feedback. For examples, Reputation is measured based on average rating of user feedback; Reliability and Availability are measured based on Probing through pinging the services; Accessibility and Response time are measured based on message interception; Cost is measured based on value collection.

Business quality includes three criteria: reputation, regulatory, and cost. Reputation represents a trustworthiness of a service; Regulatory represents a conformance with the rules of standards technology; Cost represents a unit of money that a service requestor needs to pay to invoke service. Runtime quality includes five criteria: time, reliability, availability, accessibility, response and integrity. Reliability represents the ability of a service to be executed within a maximum expected time. Availability represents the probability of service being executed at any given moment. Accessibility represents the probability of the success rate or chance of a successful service instantiation at a point in time. Response time measures the expected delay between the moment when a service operation is initiated and the time the operation sends the results. Integrity refers to how a service operation maintains the correctness of the interaction in respect to the source.

### 3.4.2 QoS Matching Algorithm

Algorithm 4 QoSMatching: Comparing QoS values of advertised
service and requested services with UP.QoS. Return TRUE
if the user satisfies; Otherwise return FALSE.

| | |
|---|---|
| 1: | function QoSMatching(R, P) |

| | |
|---|---|
| 2: | if QoSSimilarity(R,P) ≦ UP.QoS then |

| | |
|---|---|
| 3: | return FALSE |

else

| | |
|---|---|
| 4: | return TRUE |

| | |
|---|---|
| 5: | end if |

end function

The proposed QoS ontology has covered the majority of aspects of QoS services which are emerging in current literatures. However, it does not cover all aspects of QoS service as different specific applications may require different specific criteria. The embodiment's system for handling QoS is generic so it is straightforward to add new criteria.

Algorithm 4 presents the embodiment's algorithm for QoS matching. The algorithm uses Definition 5 QoSSimilarity(R,P) (Section 1) to define the matching value between R and P. It then compares the value with UP.QoS, the User Preference for QoS. The algorithm returns FALSE if the matching value is lesser than UP.QoS otherwise returns TRUE. The value is lesser than UP.QoS meaning that the QoS value advertised is under the requester's expectation. On the other hand, if the value is greater than UP.QoS, it implies that the QoS value advertised is better than the requester expectation.

### 3.5 Service Selection

Service selection is a process of arriving at a list of best discovered services. This is done by first scoring the services and then ranking them. Our service selection comprises the following three steps:
Semantic Service Score Computation: This step computes a score based on the matching levels associated with the discovered service.
User Profile Based Similarity Computation: This step computes a score by comparing the discovered service with the user profile, context and behavior analytics computed from service logs.
Service Ranking: This step aggregates the two scores and recommends the best services to the user.

The three steps are described in detail as follows.

### 3.5.1 Step 1: Semantic Service Score Computation

Among the service description returning by the discovery process, we need to rank the services and then choose the best services. The best advertised services are the services that have the highest similarities to the requested service. The similarities are computed based on IO, Constraint, and QoS of the two services.

Let D is a list of discovered services for requested service R. DiεD is a discovered service in the list. Matching between a request R and Di is measured based on three matching components, namely, IO, Constraint, and QoS. The result of each matching component is a list of semantic values, namely, Exact match, Subsume match, Invert-Subsume match, Partial match, and Fail match.

For example, IO matching considers concept matching between each concept in R and concepts in Di as R and Di consisting of several concepts representing inputs and outputs. These concepts matching will return a value in one of the similarity values: Exact match, Subsume match, Invert-Subsume match, Partial match, and Fail match. Therefore, after IO matching, we will have a list of these similarity values. This principle is also applied for Constraint matching and QoS matching.

Let X is a matching component variable, X={IO, Con, QoS} representing IO matching, Constraint matching, and QoS matching. Let Y is a number of semantic similarity representing Exact, Subsume, Invert-Subsume, Partial, and Fail. n_{Y(X)} is a number of semantic similarity Y returned by matching component X. Take IO matching example, n_{E(IO)} is the number of Exact; n_{S(IO)} is the number of Subsume; n_{I(IO)} is number of Invert-Subsume; n_{P(IO)} is the number of Partial; and n_{F(IO)} is the number of Fail. Semantic Similarity of IO between R and Di is given as follow:

$${Sim}_{IO} ( R , Di ) = \frac{{n}_{E ( IO )} * {S}_{E} + {n}_{S ( IO )} * {S}_{S} + {n}_{I ( IO )} * {S}_{I} + {n}_{P ( IO )} * {S}_{P} + {n}_{F ( IO )} * {S}_{F}}{{n}_{E ( IO )} + {n}_{S ( IO )} + {n}_{I ( IO )} + {n}_{P ( IO )} + {n}_{F ( IO )}}$$

This principle can be also applied to Constraint and QoS in the same manner. As a result, constraint similarity is computed as follow:

$${Sim}_{Con} ( R , Di ) = \frac{{n}_{E ( Con )} * {S}_{E} + {n}_{S ( Con )} * {S}_{S} + {n}_{I ( Con )} * {S}_{I} + {n}_{P ( Con )} * {S}_{P} + {n}_{F ( Con )} * {S}_{F}}{{n}_{E ( Con )} + {n}_{S ( Con )} + {n}_{I ( Con )} + {n}_{P ( Con )} + {n}_{F ( Con )}}$$

and QoS similarity is computed as follows:

$${Sim}_{QoS} ( R , Di ) = \frac{{n}_{E ( QoS )} * {S}_{E} + {n}_{S ( QoS )} * {S}_{S} + {n}_{I ( QoS )} * {S}_{I} + {n}_{P ( QoS )} * {S}_{P} + {n}_{F ( QoS )} * {S}_{F}}{{n}_{E ( QoS )} + {n}_{S ( QoS )} + {n}_{I ( QoS )} + {n}_{P ( QoS )} + {n}_{F ( QoS )}}$$

We need to convert the semantic values Exact, Subsumes, Invert-subsume, Partial, and Fail into numeric values so that we can compute the similarities:
Exact match=S_{E}
Subsumes match=S_{S}
Invert_Subsume match=S_{I}
Partial match=S_{P}
Fail match=S_{F}

S_{E}, S_{S}, S_{I}, S_{P}, and S_{F} are numerical values given by users but they usually must satisfy S_{E}>S_{S}>S_{I}>S_{P}>S_{F}.

Finally, Sim_{Service}(R,Di) (Definition 10) which is the similarity of requested service R and advertised services Di is computed as follow:

Sim_{Service}(R,Di)=w₁*Sim_{IO}(R,Di)+w₂*Sim_{Con}(R,Di)+w₃*Sim_{QoS}(R,Di) (I)

where w₁,w₂, and w₃ are weights given by user depending on the importance of the component and w₁+w₂+w₃=3.

After obtaining the Sim_{Service} of all services in the list of discovered services D, we need to perform a sorting operation to sort the discovered services based on the Sim_{Service}. Top m services in the sorted list will be selected depending on the users and applications. These m services are used by the next step to check how user should be interested in them based on the user profile.

### Example 7

(Semantic Service Score Computation): Consider requested service Sᵣ and the five advertised services described in Example 1. We compute Sim_{Service} based on this Example.

For each pair (Sᵣ,Sᵢ), there is one input matching and one output matching take into account. Input matching can be varied from Exact match to Fail match but Output matching only results in Exact matching since both the concepts refers to ‘Confirmation’ concept. Based on the results in Example 3, Sim_{IO} is computed as follows:

$${Sim}_{IO} ( {S}_{r} , {S}_{1} ) = \frac{2 * {S}_{E}}{2} = 1 * {S}_{E}$$

$${Sim}_{IO} ( {S}_{r} , {S}_{2} ) = \frac{1 * {S}_{E} + 1 * {S}_{S}}{2}$$

$${Sim}_{IO} ( {S}_{r} , {S}_{3} ) = \frac{1 * {S}_{E} + 1 * {S}_{I}}{2}$$

$${Sim}_{IO} ( {S}_{r} , {S}_{4} ) = \frac{1 * {S}_{E} + 1 * {S}_{P}}{2}$$

$${Sim}_{IO} ( {S}_{r} , {S}_{5} ) = \frac{1 * {S}_{E} + 1 * {S}_{F}}{2}$$

Also, based on the results in Example 3, Sim_{Const} is computed as follows:

$${Sim}_{Con} ( {S}_{r} , {S}_{1} ) = \frac{1 * {S}_{E}}{1} = 1 * {S}_{E}$$

$${Sim}_{Con} ( {S}_{r} , {S}_{2} ) = \frac{1 * {S}_{S}}{1} = 1 * {S}_{S}$$

$${Sim}_{Con} ( {S}_{r} , {S}_{3} ) = \frac{1 * {S}_{I}}{1} = 1 * {S}_{I}$$

$${Sim}_{Con} ( {S}_{r} , {S}_{4} ) = \frac{1 * {S}_{P}}{1} = 1 * {S}_{P}$$

$${Sim}_{Con} ( {S}_{r} , {S}_{5} ) = \frac{1 * {S}_{F}}{1} = 1 * {S}_{F}$$

Again, based on the results in Example 3, Sim_{QoS} is computed as follows:

$${Sim}_{QoS} ( {S}_{r} , {S}_{1} ) = \frac{1 * {S}_{E}}{1} = 1 * {S}_{E}$$

$${Sim}_{QoS} ( {S}_{r} , {S}_{2} ) = \frac{1 * {S}_{S}}{1} = 1 * {S}_{S}$$

$${Sim}_{QoS} ( {S}_{r} , {S}_{3} ) = \frac{1 * {S}_{S}}{1} = 1 * {S}_{S}$$

$${Sim}_{QoS} ( {S}_{r} , {S}_{4} ) = \frac{1 * {S}_{P}}{1} = 1 * {S}_{P}$$

$${Sim}_{QoS} ( {S}_{r} , {S}_{5} ) = \frac{1 * {S}_{F}}{1} = 1 * {S}_{P}$$

Inserting these similarity components into the formula (I) above for Sim_{Service}(R,Di), we have similarity between Sᵣ and the advertised services as follows:

$${Sim}_{Service} ( {S}_{r} , {S}_{1} ) = {w}_{1} * 1 * {S}_{E} + {w}_{2} * 1 * {S}_{E} + {w}_{3} * 1 * {S}_{E}$$

$${Sim}_{Service} ( {S}_{r} , {S}_{2} ) = {w}_{1} * \frac{1 * {S}_{E} + 1 * {S}_{S}}{2} + {w}_{2} * 1 * {S}_{S} + {w}_{3} * 1 * {S}_{S}$$

$${Sim}_{Service} ( {S}_{r} , {S}_{3} ) = {w}_{1} * \frac{1 * {S}_{E} + 1 * {S}_{I}}{2} + {w}_{2} * 1 * {S}_{I} + {w}_{3} * 1 * {S}_{S}$$

$${Sim}_{Service} ( {S}_{r} , {S}_{4} ) = {w}_{1} * \frac{1 * {S}_{E} + 1 * {S}_{P}}{2} + {w}_{2} * 1 * {S}_{P} + {w}_{3} * 1 * {S}_{P}$$

$${Sim}_{Service} ( {S}_{r} , {S}_{5} ) = {w}_{1} * \frac{1 * {S}_{E} + 1 * {S}_{F}}{2} + {w}_{2} * 1 * {S}_{F} + {w}_{3} * 1 * {S}_{P}$$

With the Sim_{Service} is formed in Example 7. We now compute the values of Sim_{Service} and then rank the advertised services. We assume that the matching component IO, Constraint, and QoS are equally important. So, we put the weight for the three components as follows: w₁=w₂=w₃=1. We also assume that S_{E}=4, S_{S}=3, S_{I}=2, S_{P}=1, S_{F}=0.

$$\begin{matrix}{Sim}_{Service} ( {S}_{r} , {S}_{1} ) = {w}_{1} * 1 * {S}_{E} + {w}_{2} * 1 * {S}_{E} + {w}_{3} * 1 * {S}_{E} \\ = ( {w}_{1} + {w}_{2} + {w}_{3} ) * {S}_{E} \\ = 3 * 4 \\ = 12\end{matrix}$$

$$\begin{matrix}{Sim}_{Service} ( {S}_{r} , {S}_{2} ) = {w}_{1} * \frac{1 * {S}_{E} + 1 * {S}_{S}}{2} + {w}_{2} * 1 * {S}_{S} + {w}_{3} * 1 * {S}_{S} ) \\ = 1 * \frac{1 * 4 + 1 * 3}{2} + 1 * 1 * 3 + 1 * 1 * 3 \\ = 9.5\end{matrix}$$

$$\begin{matrix}{Sim}_{Service} ( {S}_{r} , {S}_{3} ) = {w}_{1} * \frac{1 * {S}_{E} + 1 * {S}_{I}}{2} + {w}_{2} * 1 * {S}_{I} + {w}_{3} * 1 * {S}_{S} \\ = 1 * \frac{1 * 4 + 1 * 2}{2} + 1 * 1 * 2 + 1 * 1 * 3 \\ = 8\end{matrix}$$

$$\begin{matrix}{Sim}_{Service} ( {S}_{r} , {S}_{4} ) = {w}_{1} * \frac{1 * {S}_{E} + 1 * {S}_{P}}{2} + {w}_{2} * 1 * {S}_{P} + {w}_{3} * 1 * {S}_{P} \\ = 1 * \frac{1 * 4 + 1 * 1}{2} + 1 * 1 * 1 + 1 * 1 * 1 \\ = 4.5\end{matrix}$$

$$\begin{matrix}{Sim}_{Service} ( {S}_{r} , {S}_{5} ) = {w}_{1} * \frac{1 * {S}_{E} + 1 * {S}_{F}}{2} + {w}_{2} * 1 * {S}_{F} + {w}_{3} * 1 * {S}_{P} \\ = 1 * \frac{1 * 4 + 1 * 0}{2} + 1 * 1 * 0 + 1 * 1 * 1 \\ = 3\end{matrix}$$

In short, the results are Sim_{Service}(Sᵣ,S₁)=12, Sim_{Service}(Sᵣ,S₂)=9.5, Sim_{Service}(Sᵣ,S₃)=8, Sim_{Service}(Sᵣ,S₄)=4.5, and Sim_{Service}(Sᵣ,S₅)=3. Therefore, the ranked list is as the following descending order: S₁,S₂,S₃,S₄, and S₅ since the higher the service similarity values, the closer between the request and advertised services. This means that S₁, S₂, and S₃ are the most suitable advertised service while S₄ and S₅ are the least suitable one. However, among these three suitable services, we need to choose the most suitable service in order to send to the user. This can be done based on user profile which contents information implying user's interest.

### 3.5.2 Step 2: Context-Aware Adaptive Score Computation

After computing the service similarity, we will have a list m of advertised services which highly match with user requirement. However, it may be that the pairs of similarities between the advertised services with the requested services are the same or very much close. In these cases, it is hard to decide which services should be sent to the users. Moreover, user personal information including user registration information, user context, and history of user behavior should be taken into account in ranking the advertised services that match with user's requirement. We propose a system that takes into account the user information to tackle this problem. Architecture of the system is presented as FIG. 6. The system includes three major components:
User explicit information: Before using the system, the user might need to register to the system, and could provide personal information to the system. This is recorded by unit 621.
Context awareness information: For example, using GPS technology, the embodiment can detect the user context information such as region, country, street, etc. Other context information includes time and so on. This is performed by unit 622.
User implicit information: When user uses the system, the system can learn about user behavior and understand more about the user. This is performed by unit 623.

Among the three components, the unit 623 for mining implicit information is the most difficult one to construct. The unit 623 performs three steps to mine implicit information from the user behavior:
Service Logging: The backend system may store all information about the history of user behaviors including what services they have chosen and what they have been doing with the system.
Behavior Analysis: This step cleans the log since the log data contains a lot of noise. It then analyses the log to understand the user behavior.
Pattern Discovery: After analyzing the log, we understand more about the user behavior and finally, we have pattern of user behavior.

The unit 623 includes a behavior analysis module, which performs the behavior analysis, and generates an output to a pattern analysis module. It further includes a QoS analysis module for extracting the QoS of the services the user selects. The output of the QoS analysis module is passed to a Service QoS Extraction unit which analyses those selected services and generates service QoS information describing them, and to a provider QoS Extraction unit which analyses the QoS of the providers of those selected services and generates provider QoS information describing them.

FIG. 6 shows how the output of the component 62 is output to databases 61, from which it is available to a context-aware adaptive scoring unit 42, which is one of the units of the component 4 in FIG. 3. As shown in FIG. 6, the database 61 include an explicit information database for storing the information output by the unit 621, a context information database for storing data output by the unit 622, and an implicit information database for storing information output by the unit 623. The implicit information database is further composed of a behavior pattern database for storing information generated by the pattern discovery process, a Service QoS information database for storing information obtained by the Service QoS Extraction unit, and a Provider QoS information database for storing information generated by the Provider QoS Extraction unit. The context-aware adaptive scoring unit 42 also receives input from a semantic service similarity unit 41 of the service selection component 4. The output of the context-aware adaptive scoring unit 42 is passed to a service ranking unit of the service selection component 4 (not shown in FIG. 6).

In the adaptive scoring unit 42, the embodiment measures how a user is interested in a service (S) by computing the following five similarity scores:
1. Matching with user registration information: Sim_{Reg}(Reg, S)
2. Matching with user context information: Sim_{usercon} (Con, S)
3. Matching with Pattern: Sim_{Pattern} (Pattern,S)
4. Matching with QoS of Service: Sim_{QoSService} (QoSS, S)
5. Matching with QoS of Provider: Sim_{QoSProvider} (QoSP, S)

The similarity score based on user profile (Sim_{UP}) is aggregated by the five score components

Sim_{UP}(UP,S)=w1*Sim_{Reg}(Reg,S)+w2*Sim_{Con}(Con,S)+w3*Sim_{Pat}(Pat,S)+w4*Sim_{QoSS}(QoSS,S)+w5*Sim QoSP(QoSP,S) (II)

where w₁, w₂, w₃, w₄, and w₅ are weights given by user depending on the importance of the component and w₁+w₂+w₃+w₄+w₅=1.

The five similarity scores are generic such that they may be custom chosen based on the particular applications. For example, for the Sim_{Reg}, it very much depends on what application the embodiment is working on so it can exploit information such as age, sex, nationality, and so on to compute the similarity. However, the embodiment can compute the similarity scores for Sim_{QoSS} and Sim_{QoSP} since the information to get these scores are much more independent.

The embodiment starts by computing Sim_{QoSS}; Sim_{QoSP} is computed in the similar manner. Assume that after the semantic service scoring process, we choose top m services with the highest similarities. Let D′ is the database of the m services. Si is one of m services in D′, S′iεD′. After analysis the user log, it is feasible to archive the services that have been used in the past history and their corresponding trust degrees which are QoS of the services. Assume that we have such n services have been used in the past and their corresponding QoS. Let DLog is the database of the n services. Sj is one of n services in DLog, SjεDLog.

The embodiment measures how interested the user is in the service Si based on how interested he/she was in the service Sj in the past. In order to do that, the embodiment checks if Si has been used or if a similar service has been use in the past. Therefore, the embodiment measures the similarity for each Si in D′ with each Sj in Dlog. Since Si and Sj are typical services as definition 6, the formula to compute the similarity Scoreᵢⱼ between Si and Sj is presented in formula (I). For each Si, the embodiment finds the highest similarity with each Sj and then compares the highest similarity with the threshold which is a number to determine how ‘similarity’ between Si and Sj is considered.

TABLE 1
Adaptive QoS Scoring Illustration

| | S1 | S2 | S3 | . . . | Sn | Matched | QoS |
|---|---|---|---|---|---|---|---|
| S′1 | Score₁₁ | Score₁₂ | Score₁₂ | . . . | Score₁ₙ | S′1 | Q1 |
| S′2 | Score₂₁ | Score₂₂ | Score₂₃ | . . . | Score₂ₙ | S′m | Q3 |
| S′3 | Score₃₁ | Score₃₂ | Score₃₃ | . . . | Score₃ₙ | S′3 | Q3 |
| . . . | . . . | . . . | . . . | . . . | . . . | . . . | . . . |
| S′m | Scoreₘ₁ | Scoreₘ₂ | Scoreₘ₃ | | Scoreₘₙ | S′2 | Qm |

Table 1 illustrates how the embodiment gets the QoS for each service Si based on the history of using service Sj. In this example, Score₁ₗ, Score₁ₘ, Score₃₃, and Scoreₘ₂ are the highest similar scores for S1, S2, S3, and Sm respectively and these scores are greater than the threshold. The algorithm to get this Sim_{QoSS} is presented in Algorithm 5. The output of the system is an array of services in D′ with a corresponding scores. These scores will be used to compute the aggregative similarity based on formula (II). Algorithm to measure Sim_{QoSP} is carried out in the same manner.

Algorithm 5 Sim_{Qos}: Computing Service Score for each
advertised Service Si in D′ based on the list
of Services Sj in DLog and the corresponding QoS scores.

| | |
|---|---|
| 1: | function Sim_{QoSService} (D′, DLog, threshold) |

| | |
|---|---|
| 2: | arrayService[m] = nil; |
| 3: | for each service Si in D′ do |

| | |
|---|---|
| 4: | Scoreᵢ = 0; |
| 5: | ServiceMatched = nil; |
| 6: | for each service Sj in DLog do |

| | |
|---|---|
| 7: | Scoreᵢⱼ = SimService(Si, Sj); |
| 8: | if (Scoreᵢⱼ > Scoreᵢ) and (Scoreᵢⱼ> threshold) then |

| | |
|---|---|
| 9: | Scoreᵢ = Scoreᵢⱼ |
| 10: | ServiceMatched = Sⱼ |

| | |
|---|---|
| 11: | end if |

| | |
|---|---|
| 12: | end for |
| 13: | arrayService[i].Score = Scoreᵢ |

| | |
|---|---|
| 14: | end for |
| 15: | return arrayService[m]; |

| | |
|---|---|
| 16: | end function |

### 3.5.3 Step 3: Service Ranking

This step is performed by the service ranking unit of the service selection component 4 in FIG. 3. The best service which is sent to the user has the highest similarity based on the above two similarities. Given R is the request; UP is user profile information; and S is a service. The formula to measure the final similarity is as follows:

Sim(R,UP,S)=w1*Sim_{Service}(R,S)+w2*Sim_{UP}(UP,S) (III)

where wᵢ and w₂ are weights given by user depending on the importance of the component and wᵢ w₂=1.

Based on the description in formula (III), the service selection will chose the service with the highest value of Sim(R,UP,S). The service selection algorithm is presented in Algorithm 6.

Algorithm 6 ServiceSelection(R, UP, D): Computing Service
Score for each advertised Service Si in database D based
on requester R and user profile UP information.

| | |
|---|---|
| 1: | function ServiceSelection(R,UP,D) |

| | |
|---|---|
| 2: | //D′ is used to store a list of discovered services |
| 3: | for each service Si in D do |

| | |
|---|---|
| 4: | Score = SimService(R,Si); |
| 5: | D′[i].Service = Si; |
| 6: | D′[i].Score_{Service} = Score; |

| | |
|---|---|
| 7: | end for |
| 8: | Sort(D′ based on Score_{Service}) |
| 9: | Get top m service in D′ |
| 10: | for each service Si in D′ do |

| | |
|---|---|
| 11: | D′[i].Score_{UP} = 0; |
| 12: | for each service Sj in DLog do |

| | |
|---|---|
| 13: | Scoreᵢⱼ = SimUP(Si, Sj); |
| 14: | if (Scoreᵢⱼ > D′[i].Score_{UP}) then |

| | |
|---|---|
| 15: | D′[i].Score_{UP} = Scoreᵢⱼ; |

| | |
|---|---|
| 16: | end if |

| | |
|---|---|
| 17: | end for |

| | |
|---|---|
| 18: | end for |
| 19: | for each service Si in D′ do |

| | |
|---|---|
| 20: | D′[i].Score = w1*D′[i].Score_{Service} + w2*D′[i].Score_{UP}; |
| 21: | Sort(D′ based on Score) |

| | |
|---|---|
| 22: | return top service in D′; |

| | |
|---|---|
| 23: | end function |

1. A method for suggesting a plurality of services to a user, the user being associated with a service request S_{R} specified by a request dataset and defining request requirements of a service requested by the user, the request dataset including input-output (IO) data specifying the inputs and outputs of functions describing the requested service, constraint data defining constraints on the requested service, and quality of service (QoS) data defining QoS properties of the requested service,
the method using a database of advertised services, each advertised service being associated with a service profile including IO data specifying the inputs and outputs of functions describing the advertised service, constraint data defining properties of the advertised service, and QoS data defining QoS properties of the advertised service;
the method comprising:
(a) a service discovery operation of comparing the advertised services with the service request, to determine the degree of matching of the IO data, constraint data and QoS data of the request dataset with the corresponding data of the advertised services, and thereby discover advertised services consistent with at least some portion of the request dataset; and
(b) a service selection operation of:
(i) for each discovered service, using the determined degree of matching of at least the constraint data and QoS data of the request dataset and the corresponding data of the discovered service, to form a numerical compliance measure (Sim_{Service}) of the compliance of the discovered service with the request dataset; and
(ii) ranking the discovered services using the numerical compliance measure,
(c) an operation of presenting the user with the one or more most-highly ranked discovered services, whereby the user can select one of the discovered services.

2. The method of claim 1 in which the operation of determining the degree of matching of the IO data, constraint data and QoS data of the request dataset with the corresponding data of the advertised services comprises, for each of a plurality of elements of the data, identifying which of at least three categories the relationship between the element of the request dataset and the corresponding element of the service profile of the advertised service falls into.

3. The method of claim 2 in which each of the categories is associated with a numerical value, and the numerical compliance measure for each discovered serviced is formed as a weighted sum of the numerical values associated with the determined categories.

4. The method of claim 2 in which during the service selection operation the numerical compliance measure is calculated in respect of each of the discovered services, and in respect of at least one some of the IO data, at least some of the constraint data and at least some of the QoS data of the request dataset.

5. The method of claim 2 in which each said category is selected from a group comprising:
(i) an exact match category, if the corresponding data of the request dataset and advertised service are identical;
(ii) a subsume match category, for which the discovered service provides a super-set of the request requirements;
(iiii) an invert-subsume match category, for which the discovered service provides a subset of the request requirements;
(iv) a partial match category, for which the discovered service has properties which overlap with the request requirements; and
(v) a fail match category, for which the discovered service has properties which do not overlap with the request requirements.

6. The method of claim 2 in which the plurality of service profiles are defined using a common ontology based on concepts, at least one of said constraints of the service request being a complex constraint which is defined by a plurality of the atomic constraints defined based on a single one of said concepts.

7. The method of claim 2 in which the service discovery operation is defined based on input from the user which defines which of said matching categories are regarded as indicating that advertised services are consistent with said portion of the request dataset.

8. The method of claim 1 in which said ranking operation further employs data specific to the user.

9. The method of claim 8 in which in operation of ranking the discovered services is performed based on a measure which is a weighted sum of said numerical compliance measure Sim_{Service} and a user-specific numerical compliance measure Sim_{UP}.

10. The method of claim 8 in which the data specific to the user comprises preference data supplied by the user during a user registration procedure prior to the reception of the service request, the method comprising calculating said user-specific numerical compliance measure Sim_{UP} using a parameter Sim_{Reg} describing similarity between an advertised service and the preference data.

11. The method of claim 8 in which the data specific to the user comprises context data relating to how the user submitted the service request, the method comprising calculating said user-specific numerical compliance measure Sim_{UP} using a parameter Sim_{UserCon} describing similarity between an advertised service and the context data.

12. The method of claim 8 in which the data specific to the user comprises data generated from previous usage of the method by the user.

13. The method of claim 12 in which the data generated from previous usage of the method is subject to a behaviour pattern discovery algorithm to identify a pattern of usage, the method comprising calculating said user-specific numerical compliance measure Sim_{UP} using a parameter Sim_{Pattern} describing similarity between an advertised service and the pattern.

14. The method of claim 12 in which the data generated from previous usage of the method is subject to a quality of service analysis to identify QoS features of advertised services previously selected by a user, the method comprising calculating said user-specific numerical compliance measure Sim_{UP} using a parameter Sim_{QoSService} describing similarity between an advertised service and the identified QoS features.

15. The method of claim 12 in which the data generated from previous usage of the method is subject to a quality of service analysis to identify QoS features of providers of advertised services previously selected by a user, the method comprising calculating said user-specific numerical compliance measure Sim_{UP} using a parameter Sim_{QoSSProvider} describing similarity between a provider of an advertised service and the identified QoS features.

16. The method of claim 1 in which said service discovery operation comprises an operation of filtering said advertised services using the input-output (IO) data of the request dataset, followed by an operation of filtering said advertised services using said constraint data of the request dataset, followed by an operation of filtering said advertised services using said quality of service (QoS) data of the request dataset.

17. An apparatus for suggesting a plurality of services to a user, the user being associated with a service request S_{R} specified by a request dataset and defining request requirements of a service requested by the user, the request dataset including input-output (IO) data specifying the inputs and outputs of functions describing the requested service, constraints which are data defining constraints on the requested service, and quality of service (QoS) data defining QoS properties of the requested service,
the apparatus comprising:
a database of advertised services, each advertised service being associated with a service profile including IO data specifying the inputs and outputs of functions describing the advertised service, constraint data defining properties of the advertised service, QoS data defining QoS properties of the advertised service;
a processor; and
a data storage device for storing computer instructions operative, when performed by the processor to cause the processor to perform:
(a) a service discovery operation of comparing the advertised services with the service request, to determine the degree of matching of the IO data, constraint data and QoS data of the request dataset with the corresponding data of the advertised services, and thereby discover advertised services consistent with at least a portion of the request dataset; and
(b) a service selection operation of:
(i) for each discovered service, using the determined degree of matching of at least the constraint data and QoS data of the request dataset and the corresponding data of the discovered service, to form a numerical compliance measure (Sim_{Service}) of the compliance of the discovered service with the request dataset; and
(ii) ranking the discovered services using the numerical compliance measure,
(c) an operation of presenting the user with the one or more most-highly ranked discovered services, whereby the user can select one of the discovered services.

18. The apparatus of claim 17 in which the operation of determining the degree of matching of the IO data, constraint data and QoS data of the request dataset with the corresponding data of the advertised services comprises, for each of a plurality of elements of the data, identifying which of at least three categories the relationship between the element of the request dataset and the corresponding element of the service profile of the advertised service falls into.

19. The apparatus of claim 18 in which each of the categories is associated with a numerical value, and the numerical compliance measure for each discovered serviced is formed as a weighted sum of the numerical values associated with the determined categories.

20. The apparatus of claim 18 in which during the service selection operation the numerical compliance measure is calculated in respect of each of the discovered services, and in respect of at least one some of the IO data, at least some of the constraint data and at least some of the QoS.

21. The apparatus of claim 18 in which a said category is selected from a group comprising:
(i) an exact match category, if the corresponding data of the request dataset and advertised service are identical;
(ii) a subsume match category, for which the discovered service provides a super-set of the request requirements;
(iiii) an invert-subsume match category, for which the discovered service provides a subset of the request requirements;
(iv) a partial match category, for which the discovered service has properties which overlap with the request requirements; and
(v) a fail match category, for which the discovered service has properties which do not overlap with the request requirements.

22. The apparatus of claim 18 in which the plurality of service profiles are defined using a common ontology based on concepts, at least one of said constraints of the service request being a complex constraint which is defined by a plurality of the atomic constraints defined based on a single one of said concepts.

23. The apparatus of claim 18 in which the service discovery operation is defined based on input from the user which defines which of said matching categories are regarded as indicating that advertised services are consistent with said portion of the request dataset.

24. The apparatus of claim 17 in which said ranking operation further employs data specific to the user.

25. The apparatus of claim 24 in which in operation of ranking the discovered services is performed based on a measure which is a weighted sum of said numerical compliance measure Sim_{Service} and a user-specific numerical compliance measure Sim_{UP}.

26. The apparatus of claim 24 in which the data specific to the user comprises preference data supplied by the user during a user registration procedure prior to the reception of the service request, the method comprising calculating said user-specific numerical compliance measure Sim_{UP} using a parameter Sim_{Reg} describing similarity between an advertised service and the preference data.

27. The apparatus of claim 24 in which the data specific to the user comprises context data relating to how the user submitted the service request, the method comprising calculating said user-specific numerical compliance measure Sim_{UP} using a parameter Sim_{UserCon} describing similarity between an advertised service and the context data.

28. The apparatus of claim 24 in which the data specific to the user comprises data generated from previous usage of the method by the user.

29. The apparatus of claim 28 in which the data generated from previous usage of the method is subject to a behaviour pattern discovery algorithm to identify a pattern of usage, said user-specific numerical compliance measure Sim_{UP} being calculated using a parameter Sim_{Pattern} describing similarity between an advertised service and the pattern.

30. The apparatus of claim 28 in which the data generated from previous usage of the method is subject to a quality of service analysis to identify QoS features of advertised services previously selected by a user, said user-specific numerical compliance measure Sim_{UP} being calculated using a parameter Sim_{QoSService} describing similarity between an advertised service and the identified QoS features.

31. The apparatus of claim 28 in which the data generated from previous usage of the method is subject to a quality of service analysis to identify QoS features of providers of advertised services previously selected by a user, the method comprising calculating said user-specific numerical compliance measure Sim_{UP} using a parameter Sim_{QoSSProvider} describing similarity between a provider of an advertised service and the identified QoS features.

32. The apparatus of claim 17 in which said service discovery operation comprises an operation of filtering said advertised services using the input-output (IO) data of the request dataset, followed by an operation of filtering said advertised services using said constraint data of the request dataset, followed by an operation of filtering said advertised services using said quality of service (QoS) data of the request dataset.
